(19) United States
(12) Patent Application Publication
(10) Pub. No.: US 2003/0218626 A1
(43) Pub. Date: Nov. 27, 2003

(54) Method and business model for providing simulated concert recording

(76) Inventor: Benjamin P. Greene, Chicago, IL (US)

Correspondence Address: Richard C. Himelhoch, Esq., Wallenstein & Wagner, Ltd., 53rd Floor, 311 South Wacker Drive, Chicago, IL, 60606-6622, US

(21) Appl. No.: 10/153,447

(22) Filed: May 22, 2002

(51) Int. Cl. H04N 5/222; G09G 5/00

(52) U.S. Cl. 345/723; 345/727; 348/722

(57) ABSTRACT

A method and business model for simulating a performance in a concert setting and providing an audio and video recording thereof. A customer selects a song to perform. The customer performs the selected song on a platform setting with a neutral background. The customer's performance is recorded, and is combined with a previously recorded image of concert fans and a concert stage to create an appearance of the customer performing the selected song at an actual concert. The combined recording is formatted onto a recording medium, such as a compact disk (CD), video tape, or DVD, and is sold to the customer.

### DESCRIPTION

### TECHNICAL FIELD

The present invention is generally directed to a method and business model for simulating a concert and obtaining a recording of the simulated concert; and more particularly, to a method and business for creating an audio and video recording of a customer performing a song on a neutral platform, combining the customer's performance with a concert setting recording to create a recording simulating the customer performing in an actual concert setting.

### BACKGROUND OF THE INVENTION

Many people often imagine what it would be like to perform on stage like their favorite performers. However, unless they are extremely talented, very lucky or both, they will never have such fantasies fulfilled.

One form of creative outlet for such people is performing at karaoke bars. At these locations, one can select and sing along to a song of their choice before the crowd at the bar. However, unless a friend videotapes that event, there is no lasting record of the performance. Moreover, while many people desire to perform, some are too shy to get in front of a live audience.

The present invention provides the general public with an opportunity to perform on a stage (either with or without observers), and to obtain a recording of their performance that is enhanced to simulate a performance before a live audience at a major concert venue. Moreover, they can obtain this experience at their local mall.

### SUMMARY OF THE INVENTION

The present invention is a method and a business model for a business for creating a video recording of a simulated concert. A customer is recorded singing or lip-synching a song of their choice. This recording is then layered over pre-recorded live band images (e.g., a concert stage with a live audience). The resultant combined recording is then placed on a CD, video tape (e.g., VHS) or DVD, and is sold to the customer. Superimposing the customer's performance into the live band images provides an effect wherein the customer appears to be performing in a concert environment. The business is directed toward the general public (especially the non-professional singer or musician), and is preferably set up as one of the plurality of stores located in a retail mall.

In one embodiment of the invention a method is provided for simulating a live concert and providing an audio and video recording thereof to the performing customer. The method includes the step of providing a platform setting with a video transferable background for performance of a song by a customer. The platform setting is mock stage for the customer's performance of the song. The video transferable background is any background, such as a blue screen or green screen that can be removed and replaced with other images (e.g., the so-called blue screen technology typically utilized by Hollywood wherein actors acting in front of a blue screen are then superimposed onto other locations).

The method further includes facilitating the performance of the song by the customer. This may include providing music for the performance. The music may be from a selection of songs either with sung lyrics (for lip-synching customers) or without sung lyrics (e.g., just musical instruments and/or background singing—for those customers desiring to sing the song themselves). Additionally, the facilitating step may include providing microphones, musical instruments, costumes and other equipment for the performance.

Once a song is selected (and the customer is optionally provided with the appropriate equipment), it is played by a sound system and the customer is recorded performing the song. In this step the method includes creating an audio and video recording of the performance by the customer. One or more cameras are set up around the platform setting to obtain this recording. The store operator, either alone, or with the customer's assistance or input, can edit the recording to choose certain camera angles (when using more than one camera) for various portions of the performance.

The method further includes providing one or more recordings of a concert stage and/or an audience. This is typically pre-recorded footage of a concert stage with a live audience viewing the stage. The footage may be either from an actual concert (especially one where the selected song was performed by a live band or performer), or an orchestrated concert performance arranged especially for purposes of providing footage for use by the store.

The store operator then combines or superimposes the audio and video recording of the performance by the customer with the selected recording of a concert stage and audience to create a simulated audio and video concert recording. The resultant combined recording will appear to have the customer performing in a live concert setting. This combined recording is then placed on a transferable or portable medium, such as a CD, video tape cassette or DVE, and is sold to the customer.

A video camera is utilized to record the customer's performance. Preferably, the method includes utilizing a digital video camera to create a digital recording of the performance.

For purposes of this invention, the step of selling the recording to the customer refers to selling the recording directly to the performing party(ies)s as well as to someone on behalf of the performer(s). For example, the selling step is still met if the parent of a teenager doing the actual performance, pays for the recording regardless of whether the parent assisted in the performance.

In another embodiment of the invention, a method of creating a simulated concert video for personal use comprises the steps of providing a blue screen platform for a performance by a customer and providing a plurality of songs for the performance. The method further includes selecting a first song from the plurality of songs by the customer, and creating an audio and video recording of the customer performing the first song on the platform. A first concert setting recording is selected from a plurality of recordings of concert settings, and the audio and video recording of the customer performing the first song is superimposed over the first concert setting recording to create a simulated concert recording. The simulated concert recording is placed on a compact disk, video tape cassette or DVD, and is sold to the customer.

The first concert setting recording may comprise a recording of a concert stage and an audience viewing the concert stage in one recording. Alternatively, multiple layers can be employed (this can applied to the other embodiments as well). In this regard, there may be a recording of a stage and a separate recording of an audience, and all three recordings (i.e., the stage, audience, and customer's performance) can be superimposed to create the simulated concert video recording. This may allow for a greater selection to create a unique simulated concert (i.e., allowing the customer to have multiple choices for stages and multiple choices for audience views). Again, the store operator, with or without the customer's input, can edit the multiple images for the combined recording.

In yet another embodiment, a method for creating an audio visual recording on a portable medium of a simulated concert of a customer performing a song before an audience comprises providing a commercial establishment accessible to the general public having a stage of a uniform color that can be removed from a video image. The method further comprises recording a customer performing a song on the stage; combining the recording of a customer performing a song on the stage with a recording of a concert setting to create a combined recording. The method further comprises placing the combined recording on a portable recording medium, and selling the recording medium to the customer. Preferably, the method includes locating the commercial establishment in a mall.

The present invention combines the performance aspects of Karaoke, with modern video technology to create a personal entertainment video.

Further aspects of the invention are disclosed in the detailed description of the preferred embodiment, the drawings and the claims.

### BRIEF DESCRIPTION OF THE DRAWINGS

FIG. 1 is a top plan representation of an in store stage for performance of a song by a customer for use in a combined recording in accordance with an embodiment of the invention;

FIG. 2 is a top plan representation of a concert hall stage for recording of a performance of a concert for use in a combined recording in accordance with an embodiment of the invention; and,

FIG. 3 is a top plan view of an audience for recording of an audience for use in a combined recording in accordance with an embodiment of the present invention.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to a method for creating a simulated concert video and to a business for providing an in-store service for creating the video. The in-store service is intended for the non-professional public. The business or store provides a setting to allow a customer to create the effect, for the costumer's amusement and entertainment, of performing a song with their favorite band. A recording of the customer performing the song is layered with actual concert footage and is placed on a CD, video cassette (e.g., VHS) or DVD for sale to the customer.

The business or store is preferably located in a shopping mall space or parcel. This allows for marketing to the general public, especially teenagers and other interested in music and performing. The purpose of the store is to record customers singing or lip-synching to a song of their choice in front of a green/blue screen. This recording is then combined (i.e., superimposed) with pre-recorded concert video footage. The combined recording is a video of the customer appearing to perform the song on a concert stage in front of an audience.

A customer 10 entering the store signs or checks in with a receptionist who will either confirm an arranged appointment time or will schedule an appointment with a customer. At this time, the customer is provided with any rules or regulations involved in creating the recording, and fills out any paperwork associated therewith. Preferably, the customer is provided with an extensive play list of songs that may be performed. Similar to Karaoke, the songs may include just the music, or both the music and the lyrics (preferably sung by a professional performer). The music with the lyrics (while it may be used by those customers that will sing along with the professional performer), is typically utilized by those customers that intend to lip-synch. Additionally, the customer may provide their own music (e.g., on a tape, CD, or record album).

The customer selects (or provides the music for) the song that they wish to perform, and at the scheduled time, is escorted to a stage area 12 located in the store. The store, depending on its size may have more than one stage for use by a customer. However, having multiple stages would likely require utilizing soundproofing materials to avoid overlap with other performances.

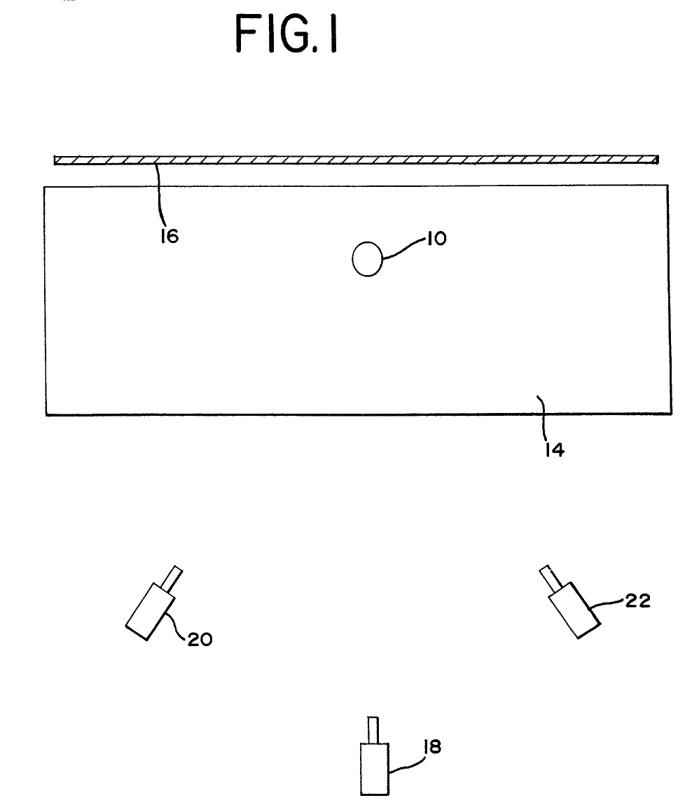

With reference to FIG. 1, the customer moves onto the a platform 14 having a green/blue screen 16 as a background. The platform may also be a green/blue color as well. A green screen or a blue screen (or items on a stage having these colors) are typically used in the entertainment industry (e.g., for movies) when it is desired to superimpose one image with another. For example, an actor performing in front of a blue screen can have computer generated characters or things added to the image, or have other recorded imagery (such as background scenes) combined with the performers recording. As is known in the art, the green or blue color, in effect, becomes transparent or non-existent and allows for combining multiple images. While green or blue are typically used for this purpose, other colors may used in a similar matter, and the reference to a green/blue screen is meant to encompass any color used.

The stage area 12 is provided with a first video camera 18, preferably a video camera, for recording the customer's performance. Additional cameras, such as a second camera 20 and a third camera 22 may also be employed to provide different angled shots of the performance. Moreover, an operator may be utilized for each camera 18, 20 and 22 who may move the camera throughout the performance, or a single operator may move the cameras by remote control. When multiple cameras are used, an operator, typically with the customer's assistance or approval can edit the views throughout the performance.

Prior to performing an operator will explain the procedure, such as where to stand or move on the platform 14, how long the performance will last, and what to do if the customer makes a mistake. When the customer is ready, the operator cues up the selected song, which is played through a sound system. The customer is then recorded singing or lip-synching live either standing, moving or dancing on the platform. To facilitate this, a monitor can be provided out of view of the cameras (e.g. on top of or behind a camera, or in the floor of the platform) for scrolling the words of the lyrics of the song. Alternatively, sheet music can be provided.

Microphones (not shown) can be placed around the stage area to record the audio portion of the recording. Alternatively, the customer can be provided with a microphone either on a stand, handheld, or extending from an earpiece worn on the customer's head. Additionally, the customer can be provided with other equipment, such as musical instruments, or costumes for use in the performance.

While the above performance was describe with respect to a single performer, more than one person can be involved in the customer's performance. For example, two or more performers can simulate a band performing a song.

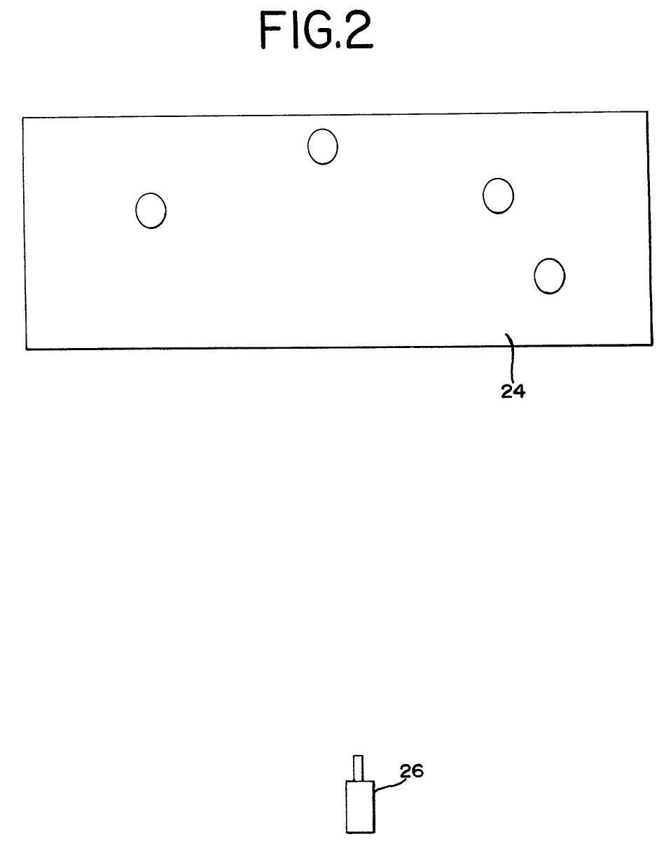

A separate recording is provided of a concert hall stage 24 (i.e., pre-recorded concert footage). The separate recording can be an actual concert footage of a band (preferably performing the selected song) or can be of just an empty concert hall stage. Preferably, the business will provide a plurality of different concert hall (pre-recorded footage) recordings for the customer to select from. As shown in FIG. 2, the concert hall footage is obtained by using a video camera 26 (or more than one camera) to record the concert hall stage 24 (and any performance thereon). Preferably a digital camera is used, and the concert hall stage recording will be the first layer of a three layer video composition. FIG. 2 shows a typical set up (in terms of location of musicians) for a performance.

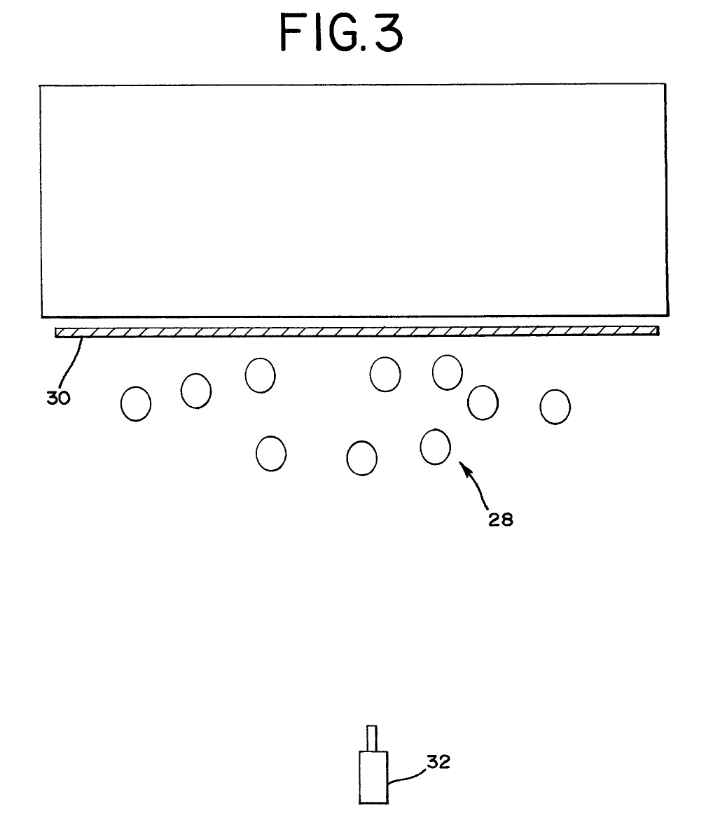

While the concert hall footage can also include views of an audience, it is preferred to use another recording of just an audience 28. This is preferably done with a digital camera in the same concert venue as the concert stage recording. As shown in FIG. 3, this is obtained by recording an audience (i.e. a crowd of people) facing a concert hall stage (either an actual one or an imaginary one). A green/blue screen 30 can be utilized as the background for the audience footage. A camera 32 (or more than one) is utilized to film the audience 28. Again, the customer is preferably provided with a plurality of audience recordings (prerecorded footage) to select from.

A computer is used to merge (i.e., superimpose) the customer's performance with the recordings of the concert hall stage recording and audience recording (for those instances that use a separate audience recording), collectively referred to as the concert footage. The computer can be set up to simultaneously superimpose the customer's performance onto the prerecorded concert footage. In this manner, a monitor may be provided for the customer off the platform but within view, so that the customer can coordinate the customer's movement with activity in the pre-recorded concert footage.

The layers, i.e., the customer's performance recording, the concert stage recording, and the audience recording, are merged to create a combined recording of the customer simulating a live concert before an audience. The simulated concert recording is then placed on a portable medium, such as a CD, video tape cassette, or a DVD, and is sold to the customer.

The simulated concert business described herein was conceived as a creative outlet that would appeal to a wide range of ages. The business allows the general public the thrill of singing on stage and seeing themselves as the star of a concert. No musical voice training is required to participate.

The business could be modified to provide additional similar services to the simulated concert recordings described above. For example, other types of performances can be superimposed with a stage and audience, such as a segment of a play or a musical or an opera. The invention can be altered to allow the customer to play an instrument in a symphony or band. The customer may be superimposed in a movie scene. Any background can be used.

While specific embodiments have been illustrated and described, numerous modifications are possible without departing from the spirit of the invention, and the scope of protection is only limited by the scope of the accompanying claims.

I claim:

1. A method of simulating a live concert and providing an audio and video recording thereof comprising the steps of:
providing a platform setting with a video transferable background for performance of a song by a customer;
facilitating the performance of said song by said customer;
creating an audio and video recording of said performance by said customer;
providing a recording of a concert stage and an audience;
combining said audio and video recording of said performance by said customer and said recording of a concert stage and audience to create a simulated audio and video concert recording.

2. The method of claim 1 wherein said providing a platform setting step comprises providing a blue screen setting.

3. The method of claim 1 further comprising placing said simulated concert recording on a transferable medium for sale to said customer.

4. The method of claim 3 wherein said placing said simulated concert recording on a transferable medium for sale to said customer comprises placing said simulated concert recording on a compact disk.

5. The method of claim 3 wherein said placing said simulated concert recording on a transferable medium for sale to said customer comprises placing said simulated concert recording on a video tape cassette.

6. The method of claim 3 wherein said placing said simulated concert recording on a transferable medium for sale to said customer comprises placing said simulated concert recording on a DVD.

7. The method of claim 1 wherein said facilitating step comprises providing said customer with audible music for said song.

8. The method of claim 7 wherein said performance comprises the step of said customer singing the lyrics of said song.

9. The method of claim 1 wherein said creating an audio and video recording of said performance by said customer comprises utilizing a digital video camera to create a digital recording of said performance.

10. The method of claim 1 wherein said combining said audio and video recording of said performance by said customer and said recording of a concert stage and audience comprises superimposing said audio and video recording of said performance by said customer into said recording of a concert stage and audience to create said simulated concert recording.

11. The method of claim 1 wherein said facilitating step comprises providing said customer with musical instruments for simulating playing of said musical instruments in said performance.

12. A method of creating a simulated concert video for personal use comprising the steps of:
providing a blue screen platform for a performance by a customer;
providing a plurality of songs for said performance;
selecting a first song from said plurality of songs by said customer;
creating an audio and video recording of said customer performing said first song on said platform;
providing a plurality of recordings of concert settings;
selecting a first concert setting recording from said plurality of recordings of concert settings; and,
superimposing said audio and video recording of said customer performing said first song with said first concert setting recording to create a simulated concert recording.

13. The method of claim 12 wherein said simulated concert recording is placed on a compact disk, and said method further comprises selling said compact disk to said customer.

14. The method of claim 12 wherein said simulated concert recording is placed on a video tape, and said method further comprises selling said video tape to said customer.

15. The method of claim 12 wherein said simulated concert recording is placed on a DVD, and said method further comprises selling said DVD to said customer.

16. The method of claim 12 wherein said first concert setting recording comprises a recording of a concert stage and an audience viewing said concert stage.

17. The method of claim 12 wherein said first concert setting recording comprises a recording of a concert stage, and said method further comprising providing a recording of an audience viewing a concert stage, and superimposing said recording of said audience with said audio and video recording of said customer performing said first song and said first concert setting recording.

18. The method of claim 12 wherein said creating an audio and video recording step comprises utilizing a digital camera to record said customer performing said first song.

19. The method of claim 12 further comprising the step of providing said platform in a business located in a shopping mall.

20. A method for creating an audio visual recording on a portable medium of a simulated concert of a customer performing a song before an audience comprising:
providing a commercial establishment accessible to the general public having a stage of a uniform color that can be removed from a video image;
recording a customer performing a song on said stage;
combining said recording of a customer performing a song on said stage with a recording of a concert setting to create a combined recording;
placing said combined recording on a portable recording medium;
selling said recording medium to said customer.

21. The method of claim 20 further comprising the step of locating said commercial establishment in a mall.

22. The method of claim 20 wherein said placing said combined recording on a portable medium comprises placing said combined recording on a compact disk.

23. The method of claim 20 wherein said placing said combined recording on a portable medium comprises placing said combined recording on a video tape cassette.

24. The method of claim 20 wherein said placing said combined recording on a portable medium comprises placing said combined recording on a compact DVD.

25. The method of claim 20 further comprising the step of providing said customer with music from a plurality of songs for selection for said performance.

26. The method of claim 20 further comprising the step of providing said customer with a plurality of recordings of concert settings for selection by said customer for combining with said recording of a customer performing a song on said stage.

27. The method of claim 20 wherein said recording a customer performing a song on said stage step comprises utilizing a digital video camera.
